(19) United States
(12) Patent Application Publication
(10) Pub. No.: US 2003/0099077 A1
(43) Pub. Date: May 29, 2003

(54) Multi-layer structure of a battery protection device

(76) Inventors: Edward Fu-Hua Chu, Taipei (TW); David Shau-Chew Wang, Taipei (TW); Yun-Ching Ma, Pingtung City (TW)

Correspondence Address: Harold V. Stotland, Seyfarth Shaw, 42nd Floor, 55 East Monroe Street, Chicago, IL, 60603-5803, US

(21) Appl. No.: 10/292,655

(22) Filed: Nov. 12, 2002

(30) Foreign Application Priority Data
Nov. 12, 2001 (TW) 090219409

(51) Int. Cl. H02H 9/08

(52) U.S. Cl. 361/93.9

(57) ABSTRACT

The invention discloses a multi-layer structure of the battery protection device, which uses a plurality of over-current protection modules connected in parallel to reduce the normal resistance value. The polypropylene, glass fiber or other harder materials are appended among the plurality of over-current protection modules. Therefore, even if the over-current protection is burned out due to improper use, the short circuit of the metal conductive sheet connecting to the positive and negative poles of the battery can be avoided.

### BACKGROUND OF THE INVENTION

1. Field of the Invention

The invention relates to a battery protection device, particularly to a multi-layer structure of a battery protection device.

2. Background of the Invention

Following the current popular applications of portable electronic products such as mobile phone, notebook PC, hand-held camera and personal digital assistant, etc., the importance of the battery protection device preventing the circuit from over-current or over-temperature phenomenon gets more and more significant.

The conventional battery protection device 10, as shown in FIG. 1, includes a current sensing unit 11, an upper metal conductive sheet 16 and a lower metal conductive sheet 15. The current sensing unit 11 includes an upper electrode foil 13, a lower electrode foil 12 and a conductive material 14 with positive temperature coefficient (PTC). The upper metal conductive sheet 16 and the lower metal conductive sheet 15 are connected with the surfaces of the upper electrode foil 13 and the lower electrode foil 12 to act as conductive wires between the positive and negative poles of the secondary battery. The PTC conductive material 14 includes a polymer and a conductive filler.

Because the resistance value of the PTC conductive material 14 is sensitive to temperature variation that, during a normal operation, the resistance value thereof may be kept in extremely low value, enabling the circuit to operate normally. However, while the over current or over temperature phenomenon is happening, the resistance value thereof will increase instantly to a high resistance value state (e.g. above 10⁴ ohm) to reversely eliminate the excess current to achieve the object of protecting circuit device.

Generally, the normal resistance value of the current sensing unit 11 can be obtained with the conventional formula:

$$R = \frac{ρ \times l}{A} ,$$

wherein ρ represents the conductive coefficient, l represents the length and A represents the area. Because the volume of portable electronic instrument gets smaller and smaller, the space occupied by the battery protection device 10 needs to be reduced. Thus, according to the above formula, the normal resistance value of the battery protection device 10 will get higher and higher.

Furthermore, while the conventional battery protection device 10 burns down due to improper use, the metal conductive sheets 15, 16 connecting to the positive and negative poles of the battery will short circuit (referred to as “unsafe failure”) so that not only is the objective of battery protection not achieved, but the safety use of the battery will also be influenced.

As the volume of the secondary battery gets smaller and smaller, the requirements for the power efficiency and safety use increases. If the conventional battery protection device 10 is being assembled, not only will the normal resistance value become too high, but the safety usage will also be influenced. Thus, it is necessary to provide an effective solution for the problem.

### SUMMARY OF THE INVENTION

The major object of the invention is to provide a battery protection device with low normal resistance value, which can effectively reduce the power consumption of the battery protection device.

The second object of the invention is to provide a battery protection device which can avoid the short circuit phenomenon which occurs during burning out of the device, causing danger for the battery use.

In order to achieve the above objects and to avoid the disadvantage of the prior art, the invention discloses a multi-layer structure of the battery protection device, which uses a plurality of over-current protection modules connected in parallel to reduce the normal resistance value. The polypropylene, glass fiber or other harder materials are appended among the plurality of current protection modules. Therefore, even if the battery protection device is burned out due to improper use, the short circuit of the metal conductive sheet connecting to the positive and negative poles of the battery can be avoided.

The multi-layer structure of the battery protection device according to the invention includes a plurality of metal conductive sheets connecting to the positive and negative poles of the battery and a current sensing unit. The invention is characterized that the current sensing unit includes at least two over-current protection modules electrically connected in parallel vertically, and the at least two over-current protection modules are separated from each other by a hard insulation layer. Furthermore, the over-current protection module includes an upper electrode layer, a PTC conductive material layer and a lower electrode layer in sequence.

### BRIEF DESCRIPTION OF THE DRAWINGS

The invention will be described following the accompanied drawings, wherein:

FIG. 1 shows a conventional battery protection device;

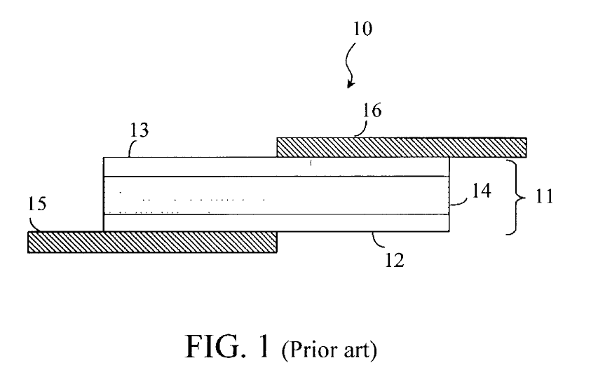

FIG. 2 shows a multi-layer structure of the battery protection device according to the first embodiment of the invention;

FIG. 3 shows an exploded diagram of each metal layer of the multi-layer structure of the battery protection device according to the first embodiment of the invention;

FIG. 4 shows a cross-sectional view along A-A′ line of the multi-layer structure of the battery protection device according to the first embodiment of the invention;

FIG. 5 shows a multi-layer structure of the battery protection device according to the second embodiment of the invention;

FIG. 6 shows an exploded diagram of each metal layer of the multi-layer structure of the battery protection device according to the second embodiment of the invention;

FIG. 7 shows a cross-sectional view along B-B′ line of the multi-layer structure of the battery protection device according to the second embodiment of the invention;

FIG. 8 shows another exploded diagram of further each metal layer of the multi-layer structure of the battery protection device according to the second embodiment of the invention;

FIG. 9 shows a multi-layer structure of the battery protection device according to the third embodiment of the invention;

FIG. 10 shows an exploded diagram of each metal layer of the multi-layer structure of the battery protection device according to the third embodiment of the invention; and

FIG. 11 shows a cross-sectional view along C-C′ line of the multi-layer structure of the battery protection device according to the third embodiment of the invention.

### DESCRIPTION OF PREFERRED EMBODIMENTS

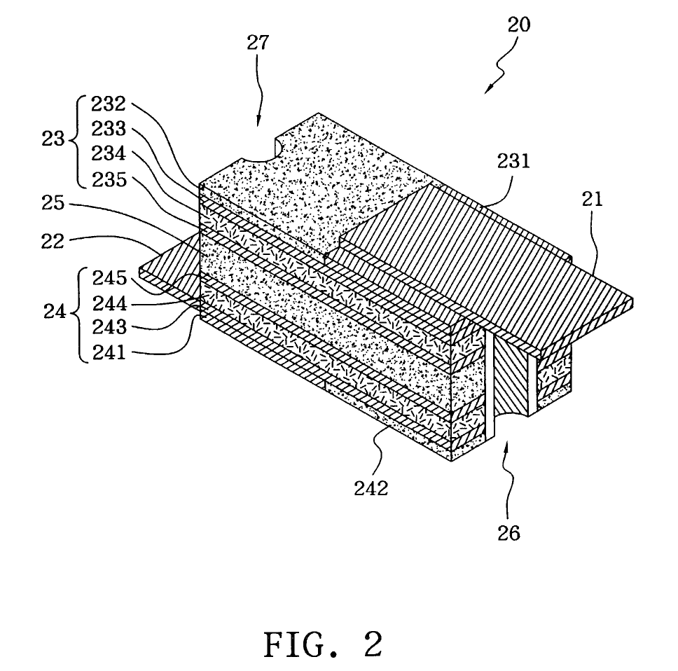

FIG. 2 is the multi-layer structure of battery protection device 20 according to the first embodiment of the invention. The major difference between the battery protection device 20 and the prior art is that there are at least two over-current protection modules 23, 24 connected with each other in parallel being included between the upper metal conductive sheet 21 and the lower metal conductive sheet 22 of the invention, thereby the resistance value and the power consumption of the device can be reduced. Referring to FIG. 2, the multi-layer structure of the battery protection device 20 of the invention includes an upper metal conductive sheet 21, a lower metal conductive sheet 22, a first over-current protection module 23, a second over-current protection module 24 and a third insulation layer 25. The first over-current protection module 23 includes a first welding layer 231, a first insulation layer 232, a first upper electrode layer 233, a first PTC conductive material layer 234 and a first lower electrode layer 235. The second over-current protection module 24 includes a second welding layer 241, a second insulation layer 242, a second lower electrode layer 243, a second PTC conductive material layer 244 and a second upper electrode layer 245. The third insulation layer 25 can be the material of polypropylene (PP) or glass fiber, etc., which not only can provide insulation effect, but can also maintain specific hardness. The first insulation layer 232 and the second insulation layer 242 can be coated with solder mask in a simpler manner, to protect the first welding layer 231 with the upper metal conductive sheet 21, and the second welding layer 241 with the lower metal conductive sheet 22 from short circuit effect due to improper connection. From the top view, the edge of the battery protection device 20 is provided with through holes 26, 27, and the inner edge thereof can be coated with conductive material by electroplating, electroless plating or filled with conductive glue.

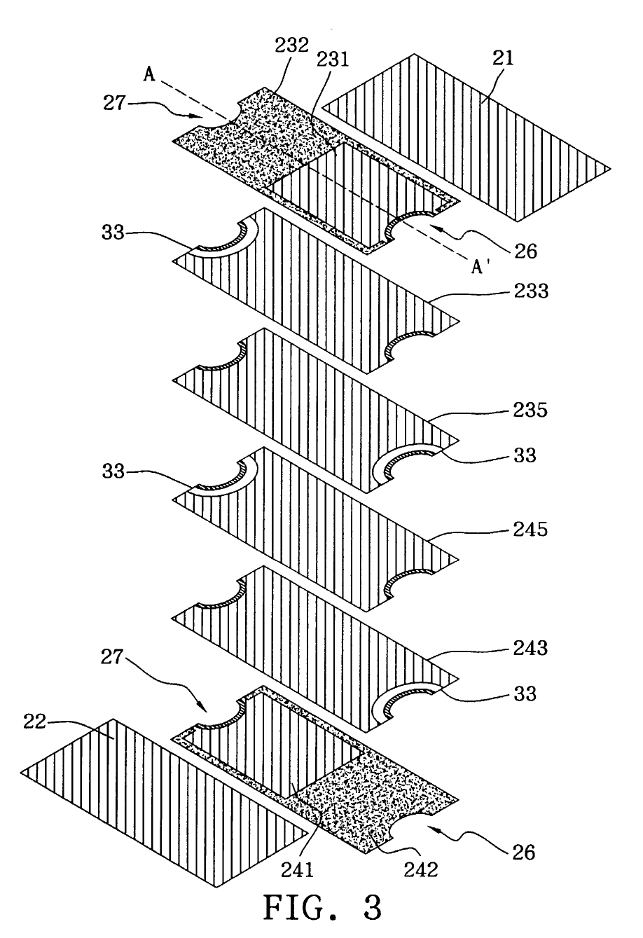

FIG. 3 is the exploded diagram of each metal layer of the multi-layer structure of the battery protection device 20 according to the first embodiment of the invention, wherein each metal layer can adopt the copper foil, nickel foil, nickel-plating copper foil, gold foil or the alloy thereof. One side of the first upper electrode layer 233, the first lower electrode layer 235, the second upper electrode layer 245 and the second lower electrode layer 241 are provided with an etching ring 33 respectively for isolating electrical connection to the through holes 26, 27. Thus, the electrical connection of the multi-layer battery protection device 20 should include two paths, wherein a first path is from the upper metal conductive sheet 21 electrically connecting to the first welding layer 23 1, the first upper electrode layer 233 and the second upper electrode layer 245 by the through hole 26, and a second path is from the lower metal conductive sheet 22 electrically connecting to the second welding layer 241, the second lower electrode layer 243 and the first lower electrode layer 235 by the through hole 27. Through the electrical connection described above, the first over-current protection module 23 and the second over-current protection module 24 are connected with each other in parallel between the upper metal conductive sheet 21 and lower metal conductive sheet 22, thereby the power consumption and the resistance value of the device can be reduced.

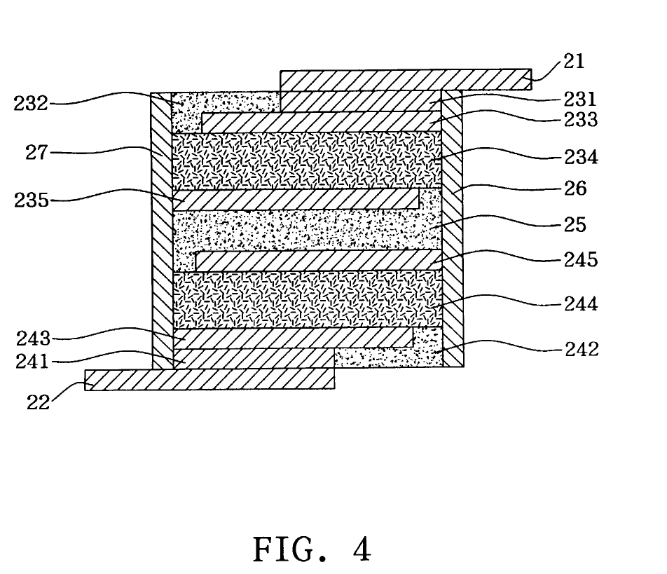

FIG. 4 is the cross-sectional view along the A-A′ line of the multi-layer structure battery protection device of the first embodiment of the invention. Obviously, the two electrically connecting paths can be verified by the cross-sectional view of FIG. 4.

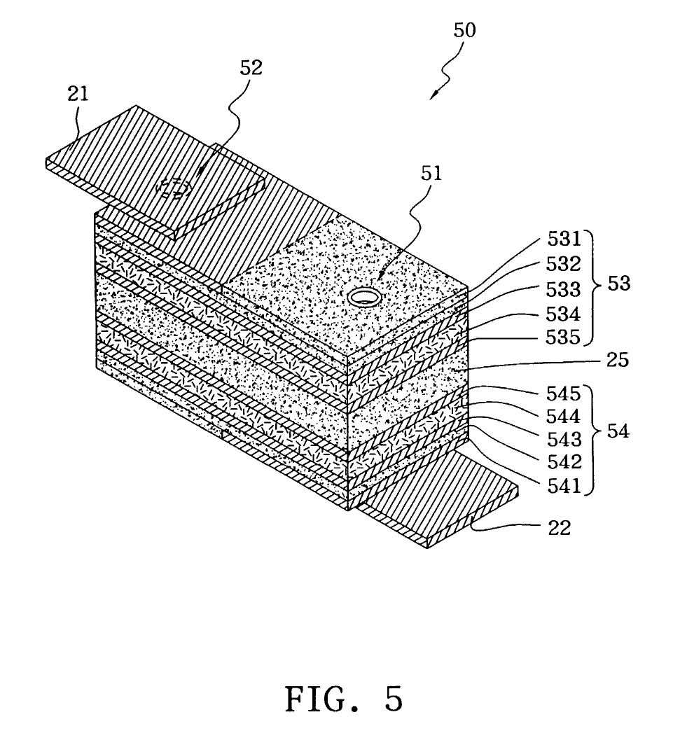

FIG. 5 is the multi-layer structure of the battery protection device 50 according to the second embodiment of the invention. The major difference between the battery protection device 50 and the multi-layer structure of the battery protection device 20 according to the first embodiment is that the through holes 51, 52 are of full circle, and not positioned at the side of the multi-layer structure of the battery protection device (i.e. semicircular conductive hole). The through holes 51, 52 pass through the whole battery protection device 50 in full circle manner, and the inner edge can be coated with conductive material through electroplating, electroless plating or filled with conductive glue. Therefore, compared with the multi-layer structure of the battery protection device 20 according to the first embodiment, the disadvantage thereof is the more consumed PTC conductive material. However, the conductive area of the full-circled through holes 51, 52 is larger than the area of the semi-circular through holes 26, 27, thus the conductive characteristic of the multi-layer structure of the battery protection device 50 according to the second embodiment will be better than the multi-layer structure of the battery protection device 20 according to the first embodiment.

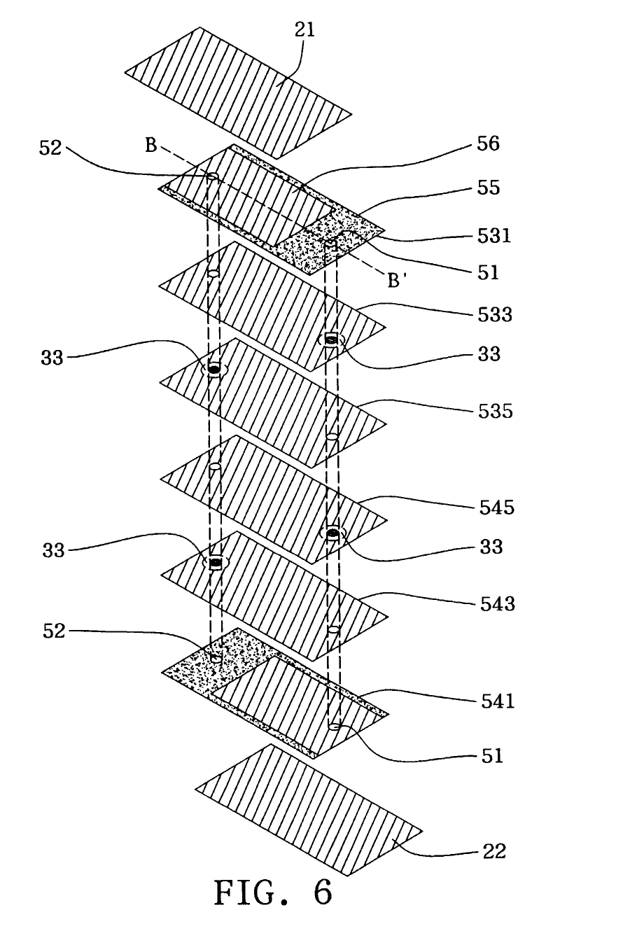

FIG. 6 is the exploded diagram of each metal layer of the multi-layer structure of the battery protection device 50 according to the second embodiment of the invention, wherein each metal layer can adopt the copper foil, nickel foil, nickel-plating copper foil or of other form. Similar to the battery protection device 20 of the first embodiment, the first welding layer 531 and the second welding layer 541 provide with an insulation region 55 and a welding region 56 respectively. The insulation region 55 can be coated with solder mask or made with the etching line (not shown) to prevent the first welding layer 531 with the upper metal conductive sheet 21 and the second welding layer 541 with the lower metal conductive sheet 22 from short circuit caused by improper use. The peripheries of the through holes 51, 52 of the first upper electrode layer 533, the first lower electrode layer 535, the second upper electrode layer 545 and the second lower electrode layer 543 provide with an etching ring 33 for isolating the electrical connection to the through holes 51, 52. Thus, the electrical connection of the multi-layer structure of the battery protection device 50 should include two paths, wherein a first path is from the upper metal conductive sheet 21 electrically connected to the first welding layer 531, the first upper electrode layer 533, the second upper electrode layer 545 by the through hole 52, and a second path is from the lower metal conductive sheet 22 electrically connected to the second welding layer 541, second lower electrode layer 543 and first lower electrode layer 535 by the through hole 51. Through the above described electrical connection, the first over-current protection module 53 and the second over-current protection module 54 are connected with each other in parallel between the upper metal conductive sheet 21 and the lower metal conductive sheet 22, thereby the power consumption and the resistance value of the device can be reduced.

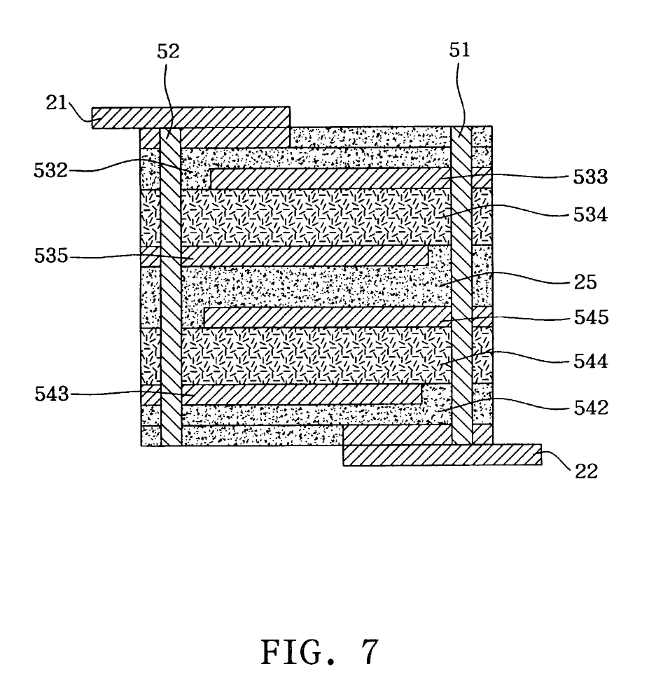

FIG. 7 is the cross-sectional view along the B-B′ line of the multi-layer structure of the battery protection device 50 according to the second embodiment of the invention. Obviously, the above two electrically connecting paths can be verified through the cross-sectional view of FIG. 7.

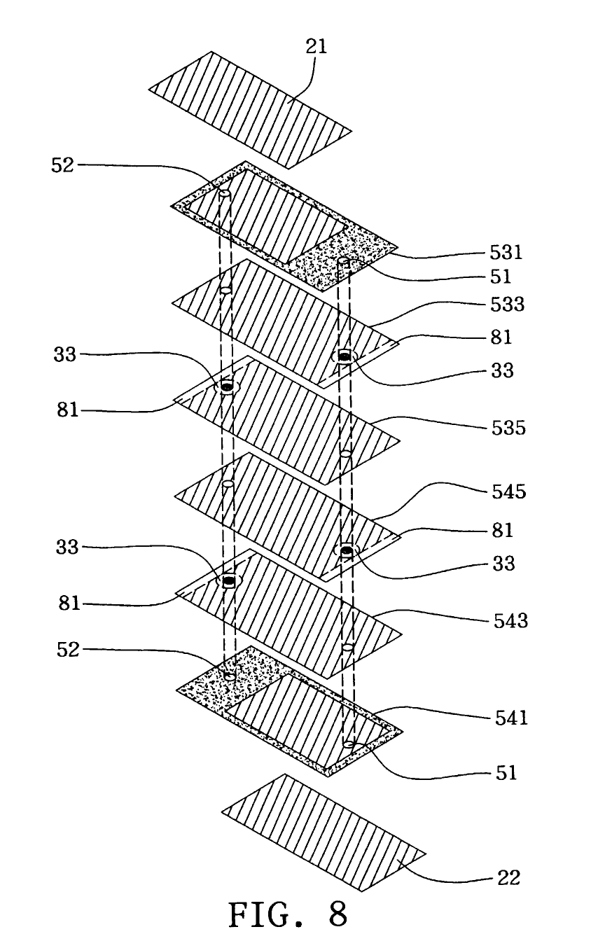

FIG. 8 is another exploded diagram of each metal layer of the multi-layer structure of the battery protection device 50 according to the second embodiment of the invention. The difference from FIG. 6 is that, as shown in FIG. 8, there is an etching line 81 provided between the side and the through holes 51, 52 of the first upper electrode layer 533, the first lower electrode layer 535, the second upper electrode layer 545 and the second lower electrode layer 541, which is used to solve the short-circuit problem resulted from improper welding.

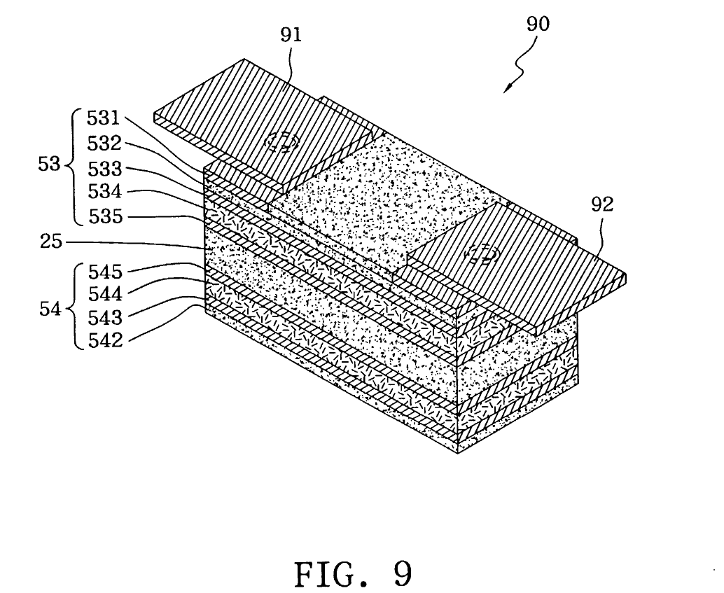

FIG. 9 is the multi-layer structure of the battery protection device 90 according to the third embodiment of the invention. The major difference between the multi-layer structure of the battery protection device 90 and the multi-layer structure of the battery protection device 50 of the second embodiment is that the first metal conductive sheet 91 and the second metal conductive sheet 92 are on the same side, but not on the opposite sides.

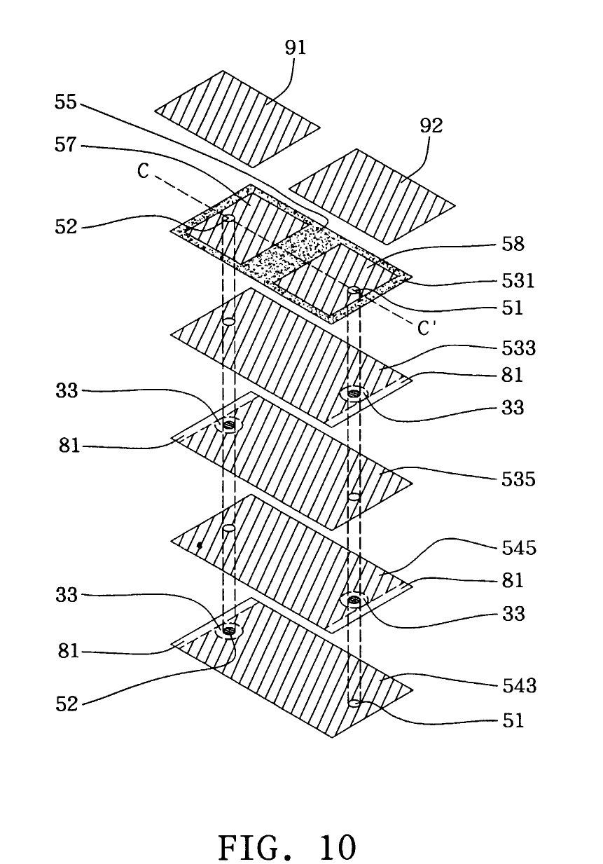

FIG. 10 is the exploded diagram of each metal layer of the multi-layer structure of the battery protection device 90 according to the third embodiment of the invention, wherein each metal layer can adopt the copper foil, nickel foil, nickel-plating copper foil or of other forms. Similar to the battery protection device 50 of the second embodiment, the first welding layer 531 provides with an insulation region 55, a first welding region 57 and a second welding region 58, and the insulation region 55 can be coated with solder mask and made with the etching line (not shown) to protect the first welding layer 531 and the first and second metal conductive sheets 91, 92 from short circuit due to improper use. The peripheries of the through holes 51, 52 of the first upper electrode layer 533, the first lower electrode layer 535, the second upper electrode layer 545 and the second lower electrode layer 543 are provided with an etching ring 33 for isolating the connection to the through holes 51, 52. Thus, the electrical connection of the multi-layer battery protection device 90 should include two paths, wherein a first path is from the first metal conductive sheet 91 electrically connecting to the first welding layer 531, the first upper electrode layer 533, and the second upper electrode layer 545 by the through hole 52, and a second path is from the second metal conductive sheet 92 electrically connecting to the first welding layer 531, the first lower electrode layer 535 and the second lower electrode layer 543 by the through hole 51. Through above described electrical connection, the first over-current protection module 53 and second over-current protection module 54 are connected with each other in parallel between the first metal conductive sheet 91 and second metal conductive sheet 92, thereby the power consumption and the resistance value of the device can be reduced. Furthermore, because the first metal conductive sheet 91 and the second metal conductive sheet 92 are welded in the first welding layer 531, the second welding layer 541 in FIG. 5 can be omitted in the battery protection device 90.

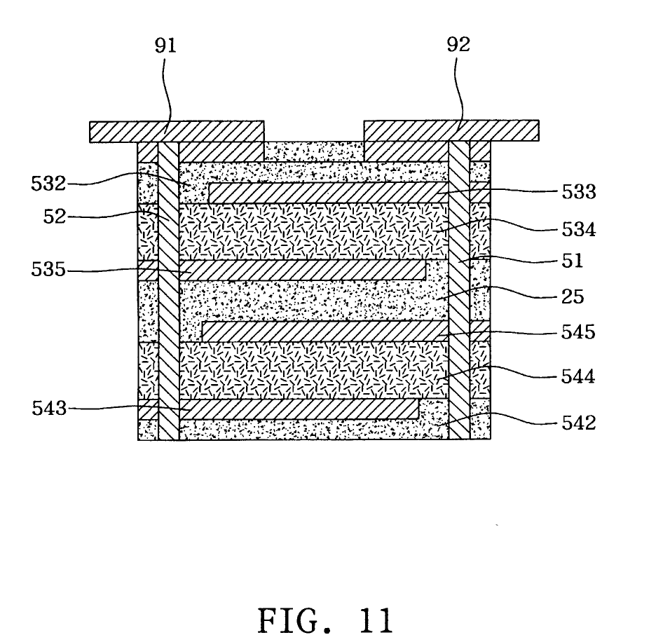

FIG. 11 is the cross-sectional view along the C-C′ line of the multi-layer structure of the battery protection device 90 according to the third embodiment of the invention. Obviously, the aforementioned two electrically connecting paths can be verified by the cross-sectional view in FIG. 11.

The technical contents and technical characteristics of the invention have been disclosed as the above, however, one skilled in the art can make various modifications and alternations, without departing from the spirit of the invention based on the teaching and disclosure of the invention. Thus, the protected scope of the invention is not restricted in the disclosure of the embodiment, and should include various modifications and alternations, without departing from the invention and should be indicated by the appended claims.

What is claimed is:

1. A multi-layer structure of a battery protection device, including metal conductive sheets connecting to positive and negative poles of a battery and a current sensing unit, wherein the current sensing unit comprises at least two over-current protection modules electrically connected in parallel, and the at least two over-current protection modules are separated from each other by a hard insulation layer, each of the over-current protection modules includes:
an upper electrode layer;
a PTC conductive material layer; and
a lower electrode layer.

2. The multi-layer structure of a battery protection device of claim 1, wherein the at least two over-current protection modules are electrically connected in parallel by full-circled through holes.

3. The multi-layer structure of a battery protection device of claim 1, wherein the at least two over-current protection modules are electrically connected in parallel by semi-circular through holes.

4. The multi-layer structure of a battery protection device of claim 1, wherein the hard insulation layer is made of polypropylene or glass fiber.

5. The multi-layer structure of a battery protection device of claim 1, wherein the upper electrode layer of the upmost over-current protection module of the current sensing unit further includes a welding layer thereon.

6. The multi-layer structure of a battery protection device of claim 1, wherein the lower electrode layer of the lowest over-current protection module of the current sensing unit further includes a welding layer underneath.

7. The multi-layer structure of a battery protection device of claim 5, wherein the metal conductive sheets are all located above the current sensing unit, and the welding layer is provided with two welding region.

8. The multi-layer structure of a battery protection device of claim 6, wherein the metal conductive sheets are all located under the current sensing unit, and the welding layer is provided with two welding regions.

9. The multi-layer structure of a battery protection device of claim 1, wherein the metal conductive sheets are located at different sides of the current sensing unit respectively.

10. The multi-layer structure of a battery protection device of claim 2, wherein an etching line is provided between the full-circled through hole and the side of the battery protection device.

11. The multi-layer structure of a battery protection device of claim 2, wherein the full-circled through hole is formed by electroplating or electroless plating or filled with conductive glue.

12. The multi-layer structure of a battery protection device of claim 3, wherein the semi-circled through hole is formed by electroplating or electroless plating or filled with conductive glue.

13. The multi-layer structure of a battery protection device of claim 1, wherein the PTC conductive material layer includes a polymer and a conductive filler.

14. The multi-layer structure of a battery protection device of claim 1, wherein the material of the upper electrode layer and lower electrode layer is selected from a group consisting of copper, nickle, gold and their alloy thereof.
